(19) United States
(12) Patent Application Publication
(10) Pub. No.: US 2026/0342095 A1
(43) Pub. Date: Oct. 29, 2026

(54) DISTRIBUTED CONTROL OF POWER SYSTEMS USING WIRELESS COMMUNICATION INFRASTRUCTURE

(71) Applicant: Alliance for Energy Innovation, LLC, Golden, CO (US)

(72) Inventors: Jordan PETERSON, Littleton, CO (US); Joshua Eli RIVERA, Thornton, CO (US); Anthony James MARKEL, Highlands Ranch, CO (US); Brian Ray MILLER, Golden, CO (US); Erich William FETH, Littleton, CO (US)

(21) Appl. No.: 19/230,974

(22) Filed: Jun. 6, 2025

Related U.S. Application Data
(60) Provisional application No. 63/657,601, filed on Jun. 7, 2024.
(60) Provisional application No. 63/771,921, filed on Mar. 14, 2025.

(51) Int. Cl. H02J 3/38; H02J 3/007; H02J 13/13; H02J 101/24; H02J 101/28

(52) U.S. Cl. CPC H02J 3/38; H02J 3/007; H02J 13/1333; H02J 2101/24; H02J 2101/28

(57) ABSTRACT

Techniques for distributed control of a power system are presented. The power system may include a plurality of power grids, each including a respective power infrastructure edge device and a respective power supply. The distributed control system may include: a plurality of hive nodes, where each hive node is assigned to a respective power grid, and where each hive node is configured to be communicatively coupled to remaining hive nodes of the plurality of hive nodes; and a plurality of worker nodes, where each worker node is associated with a respective hive node of the plurality of hive nodes, such that each worker node is associated with a respective power grid, where each worker node is communicatively coupled to its associated respective hive node via a cellular telephone network, and where each worker node controls a respective power infrastructure edge device of its respective power grid.

### CROSS-REFERENCE TO RELATED APPLICATIONS

This application claims priority from U.S. Provisional Patent Application Nos. 63/657,601 and 63/771,921 filed on Jun. 7, 2024 and Mar. 14, 2025, respectively, the contents of which are hereby incorporated herein by reference in their entireties.

### CONTRACTUAL ORIGIN

This invention was made with government support under Contract No. DE-AC36-08GO28308 awarded by the Department of Energy. The government has certain rights in the invention.

### FIELD

This disclosure relates generally to electricity distribution systems.

### BACKGROUND

Power infrastructure systems that harvest renewable energy sources, such as wind turbines, photovoltaic systems, geothermal systems, and concentrating solar power systems are inherently distributed and may be sited at locations of optimal resource availability, such as open plains and deserts, often in rural areas. However, wired communications infrastructure may not be available in such remote locations. In addition, cellular phone networks and industrial control systems have incompatible protocols. Therefore, remote control over power infrastructure edge devices presents challenges in such environments.

### SUMMARY

According to various embodiments, a distributed control system for a power system is presented. The power system may include a plurality of power grids, where each power grid of the plurality of power grids includes a respective power infrastructure edge device and a respective power supply. The distributed control system may include: a plurality of hive nodes, where each hive node is assigned to a respective power grid, and where each hive node is configured to be communicatively coupled to remaining hive nodes of the plurality of hive nodes; and a plurality of worker nodes, where each worker node is associated with a respective hive node of the plurality of hive nodes, such that each worker node is associated with a respective power grid, where each worker node is communicatively coupled to its associated respective hive node via a cellular telephone network, and where each worker node controls a respective power infrastructure edge device of its respective power grid.

Various optional features of the above system embodiments include the following. The cellular telephone network may include a 5G network. Each worker node may initiate a communication channel with its associated respective hive node via a persistent 5G communication session. At least a first hive node of the plurality of hive nodes may be communicatively coupled to at least a second hive node of the plurality of hive nodes via a wired communication channel. Each worker node may initiate a communication channel with its respective power infrastructure edge device of its respective power grid through a wired peer-to-peer connection, such that each worker node controls its respective power infrastructure edge device of its respective power grid using an industrial control system protocol. The industrial control system protocol may forbid power infrastructure edge devices from initiating communication channels with worker nodes. Each power grid of the plurality of power grids may be self-sufficient. Each power grid further may include at least one respective load, and each worker node may control the respective power infrastructure edge device of its respective power grid to distribute electricity to a respective load of its respective power grid, where each worker node controls the respective power infrastructure edge device of its respective power grid to match energy requirements of the respective load of its respective power grid. At least one hive node may query a weather Application Program Interface (API), and at least one worker node may control its respective power infrastructure edge device to preemptively shut down a power distribution to its respective load in response to a predicted weather event. The plurality of hive nodes may include a mesh network of hive nodes. Each respective power infrastructure edge device may include at least one of: a photovoltaic inverter, a solar power controller, a battery power provision system controller, a smart electricity meter, a wind turbine controller, or a power line circuit breaker. At least one hive node may be implemented on a cloud server.

According to various embodiments, a method of distributed control over a power system is presented. The power system may include a plurality of power grids, where each power grid of the plurality of power grids includes a respective power infrastructure edge device and a respective power supply. The method may be performed by a distributed control system including a plurality of hive nodes, where each hive node is assigned to a respective power grid, and a plurality of worker nodes, where each worker node is associated with a respective hive node of the plurality of hive nodes, such that each worker node is associated with a respective power grid. The method may include: communicatively coupling at least one hive node of the plurality of hive nodes to remaining hive nodes of the plurality of hive nodes; communicatively coupling at least one worker node of the plurality of worker nodes to its associated respective hive node via a cellular telephone network; and controlling, by at least one worker node of the plurality of worker nodes, a respective power infrastructure edge device of its respective power grid.

Various optional features of the above method embodiments include the following. The cellular telephone network may include a 5G network. The communicatively coupling the at least one worker node of the plurality of worker nodes to its associated respective hive node via a cellular telephone network may include the at least one worker node of the plurality of worker nodes initiating a communication channel with its associated respective hive node via a persistent 5G communication session. At least a first hive node of the plurality of hive nodes may be communicatively coupled to at least a second hive node of the plurality of hive nodes via a wired communication channel. The method may further include initiating, by the at least one worker node of the plurality of worker nodes, a communication channel with its respective power infrastructure edge device of its respective power grid through a wired peer-to-peer connection, where the controlling includes controlling using an industrial control system protocol. The industrial control system protocol may forbid power infrastructure edge devices from initiating communication channels with worker nodes. Each power grid of the plurality of power grids may be self-sufficient. Each power grid may further include at least one respective load, where the controlling includes controlling, by the at least one worker node of the plurality of worker nodes, the respective power infrastructure edge device of its respective power grid to distribute electricity to a respective load of its respective power grid, where the at least one worker node controls the respective power infrastructure edge device of its respective power grid to match energy requirements of the respective load of its respective power grid. The method may include querying, by at least one hive node, a weather Application Program Interface (API), where the controlling, by at least one worker node of the plurality of worker nodes, the respective power infrastructure edge device of its respective power grid includes the at least one worker node controlling its respective power infrastructure edge device to preemptively shut down a power distribution to its respective load in response to a predicted weather event. The plurality of hive nodes may include a mesh network of hive nodes. Each respective power infrastructure edge device may include at least one of: a photovoltaic inverter, a solar power controller, a battery power provision system controller, a smart electricity meter, a wind turbine controller, or a power line circuit breaker. At least one hive node may be implemented on a cloud server.

Combinations, (including multiple dependent combinations) of the above-described elements and those within the specification have been contemplated by the inventors and may be made, except where otherwise indicated or where contradictory.

### BRIEF DESCRIPTION OF THE DRAWINGS

Various features of the examples can be more fully appreciated, as the same become better understood with reference to the following detailed description of the examples when considered in connection with the accompanying figures, in which:

FIG. 1 illustrates schematic diagrams of an industrial control system communication paradigm, a wireless network communication paradigm, and an embodiment communication paradigm;

FIG. 2 illustrates a schematic diagram of a distributed control system for a power system, according to an embodiment;

FIG. 3 illustrates a schematic diagram of example hive node and worker node architectures, according to various embodiments;

FIG. 4 illustrates a schematic diagram of a test bed used to perform various tests of a non-limiting example embodiment;

FIG. 5 illustrates a field test site for the test bed of FIG. 4;

FIG. 6 illustrates a schematic diagram of a non-limiting example embodiment in a cross-regional environment; and

FIG. 7 illustrates a flow diagram for a method of distributed control over a power system, according to various embodiments.

### DESCRIPTION OF THE EXAMPLES

Reference will now be made in detail to example implementations, illustrated in the accompanying drawings. Wherever convenient, the same reference numbers will be used throughout the drawings to refer to the same or like parts. In the following description, reference is made to the accompanying drawings that form a part thereof, and in which is shown by way of illustration specific exemplary examples in which the invention may be practiced. These examples are described in sufficient detail to enable those skilled in the art to practice the invention and it is to be understood that other examples may be utilized and that changes may be made without departing from the scope of the invention. The following description is, therefore, merely exemplary.

Some embodiments provide security, scalability, flexibility, and resilience for power infrastructure edge devices and their assets. Embodiments may include a power grid control system, a communications system, and a method, and may utilize hardware, executable software, and/or grid edge components. Some embodiments provide a combination of a distributed control system, data storage, wired and wireless communications, and/or grid edge devices that solve the challenges of supplying secure, scalable, flexible, and resilient edge controls for distributed energy resources. Some embodiments include a resilient communications system and self-configuration method for grid edge systems and their assets. Some embodiments integrate an array of grid edge level control systems via intelligent communications driven by energy systems and communications data. Such data may be used to inform which communications path(s) the energy system controls prioritize for overall system resilience, e.g., during cyber-attacks or weather events.

Some embodiments provide distributed control system for electrical infrastructure that includes multiple power grids, e.g., microgrids. Each power grid may include one or more power infrastructure edge devices, one or more loads, and/or one or more power supplies. Power infrastructure edge devices include computing devices deployed at the power grid edge, often at points like substations, distribution transformers, and/or individual meters. The grid edge may include junctions where electricity is distributed from the utility to end users, such as homes, businesses, and other consumers. For example, distributed energy resources such as solar panels, storage systems, and electric vehicle chargers may connect to the power grid at the grid edge. Specific non-limiting examples of power infrastructure edge devices include: photovoltaic inverters, solar power controllers, battery power provision system controllers, smart electricity meters, wind turbine controllers, power line circuit breakers, Remote Terminal Units (RTUs), controllable loads, and generally any cyber-physical device that can control all or a portion of a power grid.

The distributed control system includes a plurality of hive nodes and a plurality of worker nodes. Each power grid is assigned a hive node, and each worker node is communicatively coupled to a hive node via a cellular telephone network, e.g., a 5G network. The hive nodes may communicate amongst themselves using a self-healing mesh network. Each worker node controls a power infrastructure edge device within a respective one of the power grids. The use of the cellular telephone network allows for control over power grids in areas with limited wired communications infrastructure.

These and other features and advantages are shown and described herein in reference to the figures.

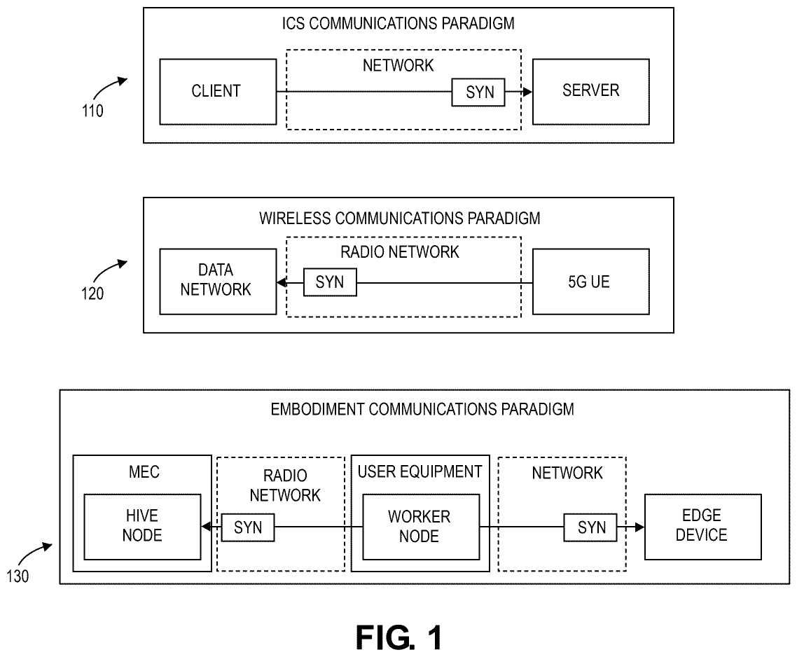

FIG. 1 illustrates schematic diagrams of an industrial control system (ICS) communication paradigm 110, a wireless network communication paradigm 120, and an embodiment communication paradigm 130. In FIG. 1 and throughout this disclosure, the term “MEC” refers to multi-access edge computing architecture, by way of non-limiting example, which may include computer hardware deployed in the cloud or on local computer hardware.

The communication paradigms shown in FIG. 1 illustrate a problem presented by the prior art, as well as its solution provided by an embodiment. In general, to establish grid control, a controller pulls (e.g., receives) updates from edge devices and pushes (e.g., sends) controls to edge devices. Traditionally, in the context of an industrial control system, such as Supervisory Control and Data Acquisition (SCADA), a controller initiates and establishes a connection to an edge device to set up a session in which both endpoints can send and receive messages, as illustrated by the diagram of the industrial control system communication paradigm 110. By contrast, as illustrated by the diagram of the wireless network communication paradigm 120, in a cellular network 5G context, for example, the edge device, e.g., a cell phone, initiates and establishes a connection through the telecommunication network to a data server to accomplish an application's desired functionality. Therefore, attempting to use a wireless network for industrial control creates a conflict of control paradigms, because the interface designs and protocols of industrial control systems and cellular telephone networks are fundamentally different.

In more detail, 5G infrastructure requires an edge device to initiate and establish a communication session, as illustrated by the diagram of the wireless network communication paradigm 120. However, in the current industrial control system communication paradigm 110, grid-edge devices of a power distribution system, for example, do not establish communication sessions due to standards that define the roles and relationships of controlling and controlled devices. Instead, in the industrial control system communication paradigm 110, edge devices (e.g., servers) listen for connections to and receive requests from controllers (e.g., clients). In the current industrial control system communication paradigm 110, an edge device (e.g., server) will not and can not reach out to a controller (e.g., client) to establish communication.

Accordingly, the embodiment communication paradigm 130 for a distributed controller system may include multiple instances of two element types: a controlling (hive) node on the network side of the 5G infrastructure and a proxy (worker) on the device side of the 5G infrastructure. According to the embodiment communication paradigm 130, each worker node may initiate and establish a (typically, but not necessarily, wired) connection to an edge device, and may initiate and establish a connection to a hive node through a wireless network, such as a cellular communication network, e.g., 5G. Establishing these communication channels may facilitate a wireless network, which uses the wireless network communication paradigm 120, interfacing with edge devices, which utilize the industrial control system communication paradigm 110.

Further, in the embodiment communication paradigm 130, from a security perspective, the preservation of the inability for communications to be initiated by an edge device according to the industrial control system communication paradigm 110 enhances security. If the user plane (or data network) allowed for communications traffic to pass through the 5G core, via the radio access network (RAN), to the edge device by default, attack scenarios against edge devices would be more likely to occur. However, because in the embodiment communication paradigm 130, worker nodes establish the trust connection through the 5G RAN and user plane before the hive node can provide control instructions, such as policies, the threat to the worker nodes is reduced. This benefits the overall security and resilience of the communications and controls approach accommodated by the embodiment communication paradigm 130.

Further advantages of the embodiment communication paradigm 130, which utilizes the worker-hive architecture, include the following. Responsibility is distributed between hive/worker nodes, which increases resilience of edge control. The embodiment communication paradigm 130 accommodates legacy devices. Worker nodes can be lightweight for fast local reaction times. The 5G edge paradigm may be maintained for security and resilience. Other features and advantages are set forth throughout this disclosure.

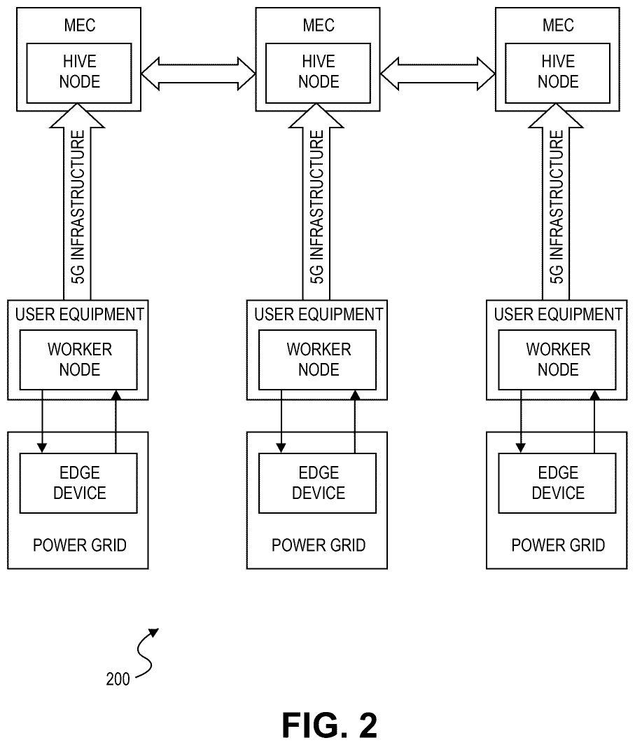

FIG. 2 illustrates a schematic diagram of a distributed control system 200 for a power system, according to an embodiment. The distributed control system 200 includes a network of hive nodes (e.g., servers) and worker nodes (e.g., clients) collaborating to provide resilient automated control over a plurality of power grids.

Any of a variety of different power grid types may be controlled. For example, each power grid may include one or more power sources, such as: at least one of a wind turbine, a solar panel, and/or a traditional power source, such as a coal-fired, an oil-fired, and/or a diesel-powered turbine. Each power grid may include one or more loads, e.g., one or more residential homes, one or more commercial buildings, traffic signal infrastructure, industrial loads (e.g., factories), etc. Each power grid may include one or more power infrastructure edge devices, which control, regulate, condition, sense, measure, or otherwise interact with other elements of the power grid, such as the power source(s). The power grids may be isolated, or two or more (e.g., all) of the power grids may be interconnected (e.g., providing and/or accepting electricity between them). Each power grid may be self-sufficient; for example, a given power grid may be capable of generating and distributing sufficient electricity to meet the requirements of all loads within the given power grid.

Referring again to FIG. 2, a distributed control system 200 may include a mesh network of hive nodes that disseminate information throughout the distributed network, and corresponding worker nodes that provide fast, responsive control to the power systems via the grid edge. Each node, whether hive or worker, may include a non-transitory computer readable medium containing instructions and at least one electronic processor that executes the instructions to perform operations as described herein. As illustrated in FIG. 2, and by way of non-limiting example, hive nodes may be implemented on MECs, and worker nodes may be implemented on user equipment. The user equipment may include computer hardware that may be owned and/or controlled by a grid utility. In general, the user equipment may include one or both of compute hardware and/or a wireless network radio, e.g., a 5G radio and interface.

Referring again to FIG. 2, the distributed control system 200 may be used to manage grid-edge power system devices such as, by way of non-limiting examples, photovoltaic inverters, solar power controllers, battery power provision system controllers, smart electricity meters, wind turbine controllers, power line circuit breakers, RTUs, and/or controllable loads. The method for controlling these power infrastructure edge devices according to some embodiments differs from traditional centralized control in that there is no master controller gathering data and dispatching control to all of the edge devices. Instead, a collection of cooperating controllers (hive and worker nodes) collaborate to share relevant data and influence each other's control of specific edge devices. A benefit of a centralized approach is the omniscience of collecting all relevant data into a single point. In a decentralized system, by contrast, timeliness of data may be sacrificed. Nevertheless, the tradeoff of omniscience for modularity, resilience, segmentation, and dispersed computing according to the decentralized approach of some embodiments does not compromise the ability to manage a collection of grid-edge devices in a sufficiently timely manner. Thus, the distributed control system 200 described herein provides a next-generation control scheme with temporal latency compatible with power system infrastructure, e.g., when paired with 5G infrastructure via MEC and user equipment.

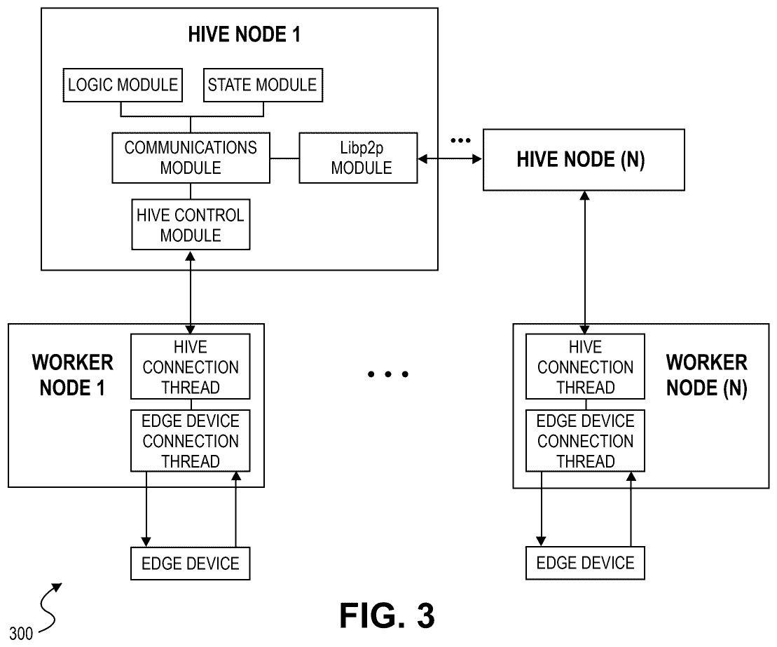

Detailed system architecture of example hive and worker nodes is shown and described presently in reference to FIG. 3, which illustrates a schematic diagram 300 of example hive node and worker node architectures, according to various embodiments. Detailed descriptions of hive nodes and worker nodes follow.

Each hive node includes a non-transitory computer readable medium containing instructions, and at least one electronic processor that executes the instructions, so as to establish the individual and overall functionality of the hive node system portion. The hive nodes may be implemented in MEC hardware, by way of non-limiting example. A hive node functionality may be conceptualized as including modules, which make up the overall functionality for communications, controls, data sharing, logic, and state monitoring across the hive portion of the system using distributed peer-to-peer communications. Detailed descriptions of the non-limiting example modules illustrated in FIG. 3 follows.

Communications Module: The communications module defines and manages the input and output channels used for each internal module to communicate with each other and with external elements. There are four channels, each represented as one direction of the two-headed arrows in FIG. 3: input from other hive nodes, output to other hive nodes, input from registered worker nodes, and output to registered worker nodes.

Hive Control Module: The hive control module manages connections to registered worker nodes, e.g., one or more worker nodes that are expressly associated and in communication with the hive node. This module receives state updates from the registered worker nodes and sends policy updates to the registered worker nodes. This module pulls messages from the worker output channel and pushes messages to the worker input channel.

Libp2p Module: The Libp2p module manages peer-to-peer connections to each neighboring hive node. The main operation of this module is to process incoming and outgoing messages for neighboring nodes. Two threads are created, one for receiving messages and inserting them into the hive input channel and one for retrieving messages from the hive output channel and broadcasting them to neighboring nodes.

Logic Module: The logic module defines and manages the control policies used by worker nodes to directly control power infrastructure (e.g., grid) edge devices, such as circuit breakers, controllable loads, and inverters.

State Module: The state module defines and manages a representation of the shared state held between all hive nodes in the distributed system. Each hive node creates an initial state, which is shared with the neighboring hive nodes. The state represents the current configuration, parameters, status, etc., of the power infrastructure edge devices. As the worker nodes update their respective hive nodes, the state representation is updated and shared to neighboring hive nodes. This state is shared between all nodes in the distributed network, e.g., such that all hive nodes are synchronized and have information on the power system edge devices across the power grids.

Each worker node may include a non-transitory computer readable medium containing instructions, and at least one electronic processor that executes the instructions, so as to establish the individual and overall functionality of the worker node system portion. The worker nodes may be implemented in user equipment, where the users are local power utilities, by way of non-limiting example. Worker nodes may use the Manufacturing Message Specification (MMS) protocol per IEC 61850-8-1, and/or Modbus, for communications with the power infrastructure edge devices. Worker node functionality may be conceptualized as including two threads, one for handling interactions with the hive node with which the worker node is in communication, and one for handling interactions with the power infrastructure edge device(s). Further, information is passed between the two threads to relay power infrastructure edge device status updates back to the hive network. The threads provide the overall functionality for communications and controls of the worker nodes. Detailed descriptions of the non-limiting example threads illustrated in FIG. 3 follows.

Hive Connection Thread: The hive connection thread is responsible for connecting, receiving from, and sending to the hive node registered with the worker node. Incoming information encompasses registration messages and policy update messages. Outgoing information encompasses state updates from the configured edge device(s).

Edge Device Connection Thread: The edge device connection thread is responsible for connecting to, receiving from, and sending to, the configured edge device(s). Outgoing information encompasses direct control commands using MMS, Modbus, or another industrial control system control protocol. Incoming information encompasses solicited and unsolicited edge device state updates.

A description of the various communications that may be used in an embodiment follows. These communications may be categorized as hive-to-hive, hive-to-worker, and worker-to-edge, as follows.

Hive-to-Hive: Hive nodes may form peer-to-peer connections with other reachable hive nodes, e.g., using the libp2p library. Connections may be encrypted, e.g., using Transport Layer Security 1.3. Over hive-to-hive communication channels, hive nodes may use a publish-subscribe gossip protocol, e.g., GossipSub, so as to allow information to be disseminated through a mesh network. For example, from moment to moment, each hive node may dynamically connect to as many other hive nodes as possible, and the hive nodes may cooperate with each other to send data amongst themselves.

Hive-to-Worker: Each hive node is coupled with a worker node (e.g., a single worker node) through a wireless network infrastructure, such as a cellular network (e.g., 5G). By way of non-limiting example, a transmission control protocol connection over 5G may send Java Script Object Notation (JSON) data representing a control policy from a hive node to a worker node. The control policy may provide power system set point instruction for how the recipient worker node controls one or more power infrastructure edge devices. A non-limiting example of a worker node policy that contains a list of “condition” and “response” pairs, which a worker node may parse as when “condition” is observed, enact “response,” appears below.

{
“policy”:
[{
   “condition”:“BATTERY_VOLT_HIGH:57400”,
   “response”:“load_control_1”
},
{
   “condition”:“BATTERY_VOLT_LOW:48500”,
   “response”:“load_control_0”
}]

}

For this worker node policy example, each of the two conditions is a set point for observed battery voltage. The responses are noncritical load control on and off. In this example policy, there are two situations described: (1) when battery voltage is above 57,400 mV, turn the load on, and (2) when battery voltage is below 48,500 mV, turn the load off. Note that policies may include any of a variety of actions in response to any of a variety of conditions, not limited to the above examples.

Worker-to-Edge: Worker nodes create a peer-to-peer connection with a power infrastructure edge device, e.g., using the MMS or Modbus protocol. Direct edge device control and retrieval of edge device status may be performed over this connection. In general, worker-to-edge communications may use an industrial control system protocol.

The above communication types and the disclosed distributed architecture provides scalability, as well resiliency and reliability in the event of communications loss across the hive node hardware (e.g., MEC), the wireless communication network (e.g., RAN), or grid edge. The fully decentralized approach also features inherent cybersecurity advantages. One such advantage is due to the relatively limited scope of each distributed controller. Instead of relying on a single point of failure, a node that crashes or that is attacked only affects one device or a small quantity of devices. This is unlike prior art centralized controllers, which manage many devices and therefore presents an attractive target for malicious attacks.

The above communication types used within the disclosed distributed architecture provide low-latency distributed power system control, according to some embodiments. In general, acceptable latency depends on the use case, system specifications, communication protocol specifications, and any other standards to which the whole system is being compared. Some embodiments may provide the decision and response functionality well below the common polling rate of the Modbus protocol, about once every 100 milliseconds (ms). The 5G and microgrid interface design may impact the overall system latency. Nevertheless, some embodiments are expected to have a latency low enough to provide power restoration within 8 ms, which is characterized as uninterruptable, seamless, power restoration.

The following presents a description of various tests of resilience and robustness performed on a non-limiting example embodiment. The tests included subjecting the example embodiment to various failure scenarios, as described in the following.

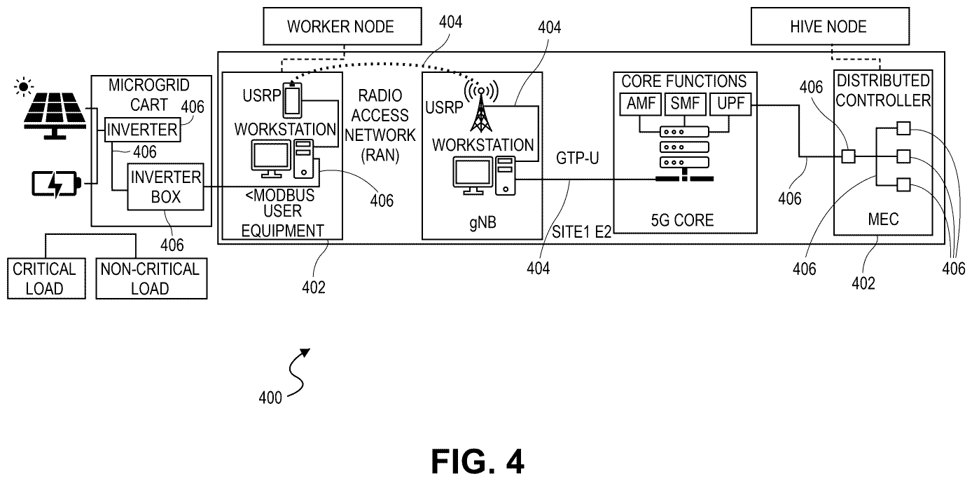

FIG. 4 illustrates a schematic diagram of a test bed 400 used to perform various tests of a non-limiting example embodiment. A hive node was programmed in Golang and implemented on a MEC. A worker node was programmed in C and implemented on user equipment (UE), a workstation. The wireless implementation used an OpenAirInterface (OAI) 5G radio access network (RAN) and a Celona 5G system. In FIG. 4, blocks labeled 402 represent administrative access to the MEC for hive node grid-edge control operations via the 5G system. Pathways labeled 404 represent the communication channel that included the general packet radio service tunneling protocol user plane connection from the 5G core user plane function (UPF), through the gNodeB (gNB) cell tower, via the universal software radio peripheral (USRP), to user equipment on the workstation. Blocks and pathways labeled 406 represent the distributed controls communications for the worker node on the UE to the grid edge device, as well as through the 5G system out of the UPF to the MEC hive node.

The test bed operated on a microgrid that itself powered the RAN and core network devices as a critical load. The microgrid included the following components: a grid-tied power line (NEMA 240v 30a), an inverter ComBox (Relay, implemented using a Schneider InsightHome), a grid-forming battery inverter (implemented using a Schneider Conext XW), an energy storage battery (implemented using a Universal UB121100), a grid-following (photovoltaic) inverter (implemented using a Fronius Primo 6), a non-critical load bank (implemented using a PTC 650-1,300 W), and a 5G Core Rack (acting as the critical load, and implemented using Celona hardware).

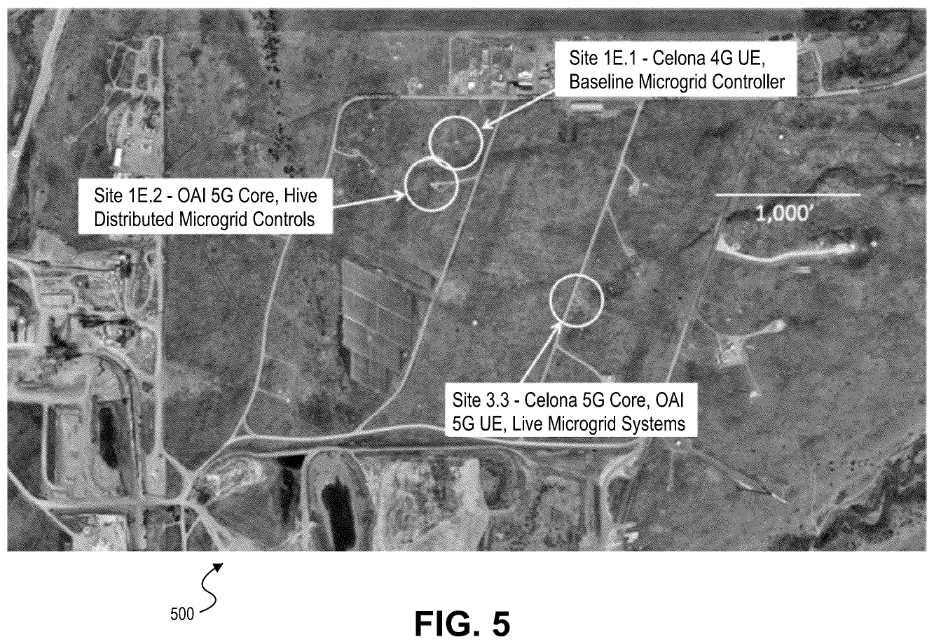

The test bed of FIG. 4 was deployed as shown and described in reference to FIG. 5.

FIG. 5 illustrates a field test site 500 for the test bed of FIG. 4. The test bed 400 and physical 5G microgrid shown and described in reference to FIG. 4 was built and tested at the 300-acre field test site 500, which contained a variety of experimental energy resources up to 20 megawatts in scale. The field test site 500 provided an open range for 5G experimentation with geographically dispersed energy resources. The field test site 500 included metal buildings, some of which containing 5G network core racks and some of which containing power grid/microgrid and energy controllers. The field test site 500 included wireless communications grid control field sites as shown in FIG. 5. Sites 1E.1, 1E.2, and 3.3 were used as individual sites to perform all microgrid test cases and controls scenarios. Sites 1E.1 and IE.2 provided the contained MEC, OAI 5G RAN, and local control integration with microgrid components. Site 3.3 housed the Celona 5G RAN and local control integration with microgrid and integrated with the MEC located at Site 1E.2.

Two scenarios were considered and applied for testing the example embodiment illustrated in FIGS. 4 and 5. These scenarios were chosen to represent the primary functions of a microgrid. A microgrid must transition from grid-following (grid-tied) mode to grid-forming (islanded) mode. This “islanding” can be done deliberately, such as to avoid grid charges or for testing and demonstration, or it can be unplanned, such as when the grid experiences an outage. While islanded, the local energy source is limited, and exceeding the limit would cause a full loss of the microgrid power, including the critical load. Therefore, both scenarios focus on controlling the noncritical load. Scenario 1 turns off the noncritical load when the microgrid's battery gets low, and Scenario 2 returns the microgrid to grid-following (grid-tied) mode if the noncritical load is too high. The scenarios are detailed below.

Scenario 1: Switch off noncritical load at a set battery threshold of 50% discharged. Switch noncritical load on at a set battery threshold of 100% charged.

Scenario 2: When in grid-forming mode (deliberately islanded even though the grid is available), if total load exceeds a threshold, switch to grid-following mode.

The primary goal of the scenarios was to test whether the example embodiment could collect, disseminate, and react to data gathered within a microgrid while segregating the responsibility and authority of managing the microgrid. The infrastructure setup is as shown and described in reference to FIGS. 4 and 5. Per the chosen policy for the test, one worker/hive pair was responsible for collecting data from the inverter. A second worker/hive pair was responsible for controlling the noncritical load as a reaction to state update information. And a third worker/hive pair was responsible for managing the grid-connectedness of the inverter.

Scenario 1 Results: The test began in the initial state with the microgrid in grid-tied mode, the noncritical load active, and the critical load active. The observed state of the inverter, battery voltage, and total load measurements were continuously pulled and relayed to the distributed network of hive nodes. The power grid then experienced an outage, and the microgrid went onto battery power. The distributed controller observed the battery voltage dropping, and at the predetermined level (50% state of charge), the distributed controller successfully shut off the noncritical load. This conserved energy until the power grid was restored, ensuring maximum battery duration for the critical load. Once the grid was restored, the distributed controller observed the battery voltage rising (charging), and at the predetermined lever (100% state of charge), the distributed controller successfully turned on the noncritical load, restoring normal operation. Thus, Scenario 1 establishes that the embodiment communication paradigm 130, which uses cellular telecommunications infrastructure in conjunction with industrial control, may be employed to effectively perform distributed control of a power system.

Note that Scenario 1 essentially subsumes an alternative scenario where the non-critical load is turned off whenever the microgrid is islanded, such as when the power grid is down. The distributed controller detects when the inverter has gone into grid forming mode and responds by disconnecting non-critical controllable load. This conserves energy while the microgrid is islanded, ensuring maximum battery duration for the critical load. The more complex test in Scenario 1 shows the example embodiment is more than capable of the simple state change of this alternative scenario.

Scenario 2 Results: The inverter was deliberately placed into grid-forming mode. The distributed controller successfully detected that the inverter was islanded and observed the electrical load amount. The load was greater than the threshold, so the distributed controller successfully shut off the noncritical load, which conserved energy while the microgrid was islanded, ensuring maximum battery duration for the critical load. Scenario 2 thus establishes that the non-limiting example embodiment, which implemented a 5G wireless network, operated to effectively control a power system in the event of islanding.

Testing was also performed to determine if the example embodiment could reliably provide resilient microgrid operations without communications between hive nodes and worker nodes. Under this test, hive nodes were prevented from connecting with, and lost their link to, worker nodes. Scenario 1 was then repeated with communications off, and the results were observed. The test began with a long-duration power outage. The test concluded that even without communications, the microgrid islanded itself and maintained power to all loads. This establishes the usefulness of hive-provided control policies being stored at, and executed by, the worker nodes.

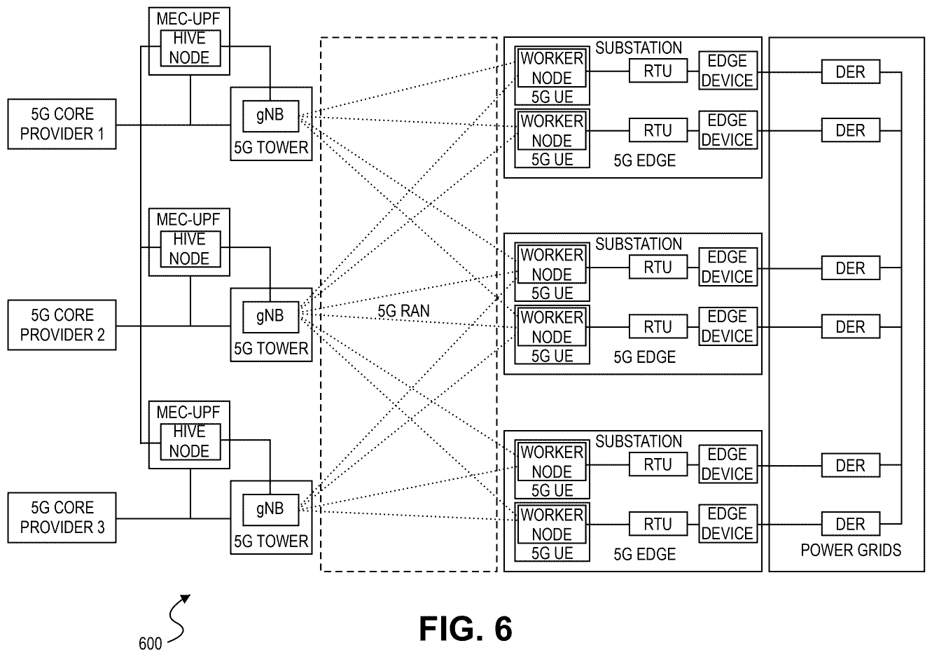

FIG. 6 illustrates a schematic diagram of a non-limiting example embodiment in a cross-regional environment 600. In FIG. 6, the term “DER” refers to Distributed Energy Source. The cross-regional environment 600 includes multiple 5G network operators (cores), 5G towers, and grid-edge (electrical power grid) equipment devices. Note that worker nodes may communicate with multiple towers, and the hive nodes collocated at each tower's MEC server can communicate with MEC applications at other towers, even if they are on different networks/cores. The cross-region environment 600 and integration approach for power system operations facilitates a resilient and reliable communications infrastructure for multi-region distributed control scenarios. By providing a fully meshed controls and communications system, operators can ensure that cross-region communications and controls are possible for the energy system during communication outages. In addition, regional systems can inform hive nodes in nearby regions of events to the power grid, providing situational awareness of weather changes and/or threats.

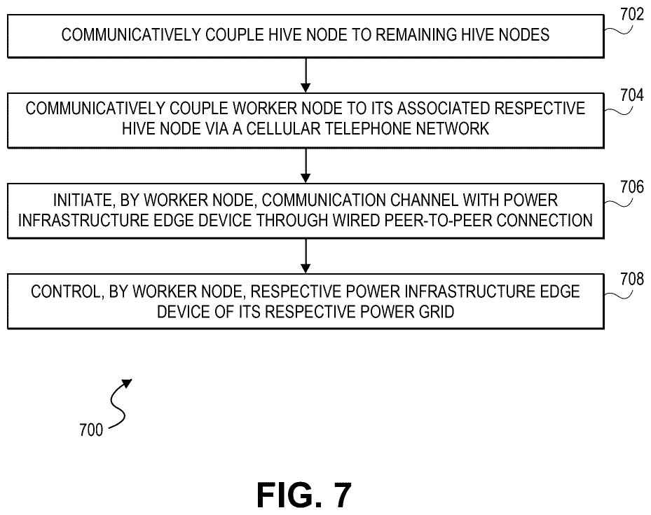

FIG. 7 illustrates a flow diagram for a method 700 of distributed control over a power system, according to various embodiments. The power system may include a plurality of power grids. Each power grid may include one or more of: a respective power infrastructure edge device, a respective load (e.g., non-critical and/or critical), and/or a respective power supply. Each power grid may be self-sufficient, e.g., capable of generating or accessing, and distributing, sufficient electricity to meet the requirements of its internal loads. Non-limiting examples of power infrastructure edge devices include: photovoltaic inverters, solar power controllers, battery power provision system controllers, smart electricity meters, wind turbine controllers, power line circuit breakers, and any other power infrastructure edge devices expressly disclosed herein or otherwise.

The method 700 may be performed using a distributed control system that includes a plurality of hive nodes and a plurality of worker nodes. Each hive node may be assigned to a respective power grid. Each worker node may be associated with a respective hive node, such that each worker node is associated with the respective power grid of the worker node's associated hive node. In general, the environment and implementation of the worker nodes and hive nodes may be as shown and described herein in reference to FIGS. 2-6. For example, one or more hive nodes may be implemented on a cloud server, and one or more worker nodes may be implemented on computer hardware that may be owned or controlled by a grid utility. The method 700 may use the embodiment communication paradigm 130 illustrated in FIG. 1.

At 702, the method 700 includes communicatively coupling at least one hive node to one or more remaining hive nodes. For example, two or more of the hive nodes may be communicatively coupled via a wired communication channel. As another example, the hive nodes may form a mesh network.

At 704, the method 700 includes communicatively coupling at least one worker node to its associated respective hive node via a cellular telephone network. The cellular telephone network may include a 5G network. According to some embodiments, the worker node may initiate a communication channel with its associated respective hive node via a persistent 5G communication session.

At 706, the method 700 includes one or more worker nodes initiating a communication channel with their respective power infrastructure edge device through a wired peer-to-peer connection. The worker node(s) may control their respective power infrastructure edge device using an industrial control system protocol. Note that the industrial control system protocol may forbid power infrastructure edge devices (e.g., servers) from initiating communication channels with worker nodes (e.g., clients).

At 708, the method 700 includes one or more worker nodes controlling their respective power infrastructure edge device(s). For example, a worker node(s) may control a respective power infrastructure edge device to distribute electricity to a load in its power grid, e.g., to match energy requirements of the load. The worker node(s) may control their respective infrastructure edge device(s) by executing a control policy that was passed from one or more hive nodes to the worker node(s).

According to some embodiments, the actions of 708 may include a worker node controlling a respective power infrastructure edge device (e.g., preemptively shutting down power distribution to a load) in response to any of a variety of events, such as a predicted weather event or a cyberattack.

For example, an embodiment may include cloud cover predictive controls. By way of non-limiting example, one or more hive nodes may either directly observe cloud cover and its changes to the outputs of solar panels, or may use weather forecast/reporting data and correlate such data with changes to the outputs of solar panels. The hive node(s) may obtain such weather data from a third party through an Application Program Interface (API), for example. Based on the observation or forecast, the hive node(s) may determine which grid portion(s) are experiencing, or would likely next experience, the weather impacts, as well as a time probability. The hive nodes may communicate amongst themselves to provide such information to worker nodes that control soon-to-be-affected power infrastructure edge devices, e.g., to proactively adjust energy storage or other resource controls so as to improve resilience potential.

As another example, an embodiment may implement a cyber-attack heightened alert status. One or more hive nodes may host cyber analytic tools to monitor the traffic within a controls network or in/out data from the network of power infrastructure edge devices. If an anomaly (e.g., threat) is detected, the detecting hive node may generate an insight profile and share it with other hive nodes. The distribution of data in this case may be geographically path based, or may be prioritized based on criticality of systems. As a result, targeted nodes may have immediate access to the necessary analysis methods and alert tools. It is possible that certain nodes may place higher priority on resilience actions or risk of attack impacts based on the current state of edge devices within their communications range.

Certain examples can be performed using a computer program or set of programs. The computer programs can exist in a variety of forms both active and inactive. For example, the computer programs can exist as software program(s) comprised of program instructions in source code, object code, executable code or other formats; firmware program(s), or hardware description language (HDL) files. Any of the above can be embodied on a transitory or non-transitory computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), flash memory, and magnetic or optical disks or tapes.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented using computer readable program instructions that are executed by an electronic processor.

These computer readable program instructions may be provided to a processor of a general-purpose computer, special purpose computer, or other programmable data processing apparatus to produce a machine, such that the instructions, which execute via the electronic processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

In embodiments, the computer readable program instructions may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the C programming language or similar programming languages. The computer readable program instructions may execute entirely on a user's computer, partly on the user's computer, as a stand-alone software package, partly on the user's computer and partly on a remote computer or entirely on the remote computer or server.

As used herein, the terms “A or B” and “A and/or B” are intended to encompass A, B, or {A and B}. Further, the terms “A, B, or C” and “A, B, and/or C” are intended to encompass single items, pairs of items, or all items, that is, all of: A, B, C, {A and B}, {A and C}, {B and C}, and {A and B and C}. The term “or” as used herein means “and/or.”

As used herein, language such as “at least one of X, Y, and Z,” “at least one of X, Y, or Z,” “at least one or more of X, Y, and Z,” “at least one or more of X, Y, or Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. § 112(f). However, for any claims containing elements designated in any other manner, it is intended that such elements are not to be interpreted under 35 U.S.C. § 112(f).

While the invention has been described with reference to the exemplary examples thereof, those skilled in the art will be able to make various modifications to the described examples without departing from the true spirit and scope. The terms and descriptions used herein are set forth by way of illustration only and are not meant as limitations. In particular, although the method has been described by examples, the steps of the method can be performed in a different order than illustrated or simultaneously. Those skilled in the art will recognize that these and other variations are possible within the spirit and scope as defined in the following claims and their equivalents.

What is claimed is:

1. A distributed control system for a power system, wherein the power system comprises a plurality of power grids, wherein each power grid of the plurality of power grids comprises a respective power infrastructure edge device and a respective power supply, the distributed control system comprising:
a plurality of hive nodes, wherein each hive node is assigned to a respective power grid, and wherein each hive node is configured to be communicatively coupled to remaining hive nodes of the plurality of hive nodes; and
a plurality of worker nodes, wherein each worker node is associated with a respective hive node of the plurality of hive nodes, whereby each worker node is associated with a respective power grid, wherein each worker node is communicatively coupled to its associated respective hive node via a cellular telephone network, and wherein each worker node controls a respective power infrastructure edge device of its respective power grid.

2. The system of claim 1, wherein the cellular telephone network comprises a 5G network.

3. The system of claim 2, wherein each worker node initiates a communication channel with its associated respective hive node via a persistent 5G communication session.

4. The system of claim 2, wherein at least a first hive node of the plurality of hive nodes is communicatively coupled to at least a second hive node of the plurality of hive nodes via a wired communication channel.

5. The system of claim 1, wherein each worker node initiates a communication channel with its respective power infrastructure edge device of its respective power grid through a wired peer-to-peer connection, whereby each worker node controls its respective power infrastructure edge device of its respective power grid using an industrial control system protocol.

6. The system of claim 5, wherein the industrial control system protocol forbids power infrastructure edge devices from initiating communication channels with worker nodes.

7. The system of claim 1, wherein each power grid of the plurality of power grids is self-sufficient.

8. The system of claim 1,
wherein each power grid further comprises at least one respective load, and
wherein each worker node controls the respective power infrastructure edge device of its respective power grid to distribute electricity to a respective load of its respective power grid, wherein each worker node controls the respective power infrastructure edge device of its respective power grid to match energy requirements of the respective load of its respective power grid.

9. The system of claim 8, wherein at least one hive node queries a weather Application Program Interface (API), and wherein at least one worker node controls its respective power infrastructure edge device to preemptively shut down a power distribution to its respective load in response to a predicted weather event.

10. The system of claim 1, wherein the plurality of hive nodes comprise a mesh network of hive nodes.

11. The system of claim 1, wherein each respective power infrastructure edge device comprises at least one of: a photovoltaic inverter, a solar power controller, a battery power provision system controller, a smart electricity meter, a wind turbine controller, or a power line circuit breaker.

12. The system of claim 1, wherein at least one hive node is implemented on a cloud server.

13. A method of distributed control over a power system, wherein the power system comprises a plurality of power grids, wherein each power grid of the plurality of power grids comprises a respective power infrastructure edge device and a respective power supply, wherein the method is performed by a distributed control system comprising a plurality of hive nodes, wherein each hive node is assigned to a respective power grid, and
a plurality of worker nodes, wherein each worker node is associated with a respective hive node of the plurality of hive nodes, whereby each worker node is associated with a respective power grid, the method comprising:
communicatively coupling at least one hive node of the plurality of hive nodes to remaining hive nodes of the plurality of hive nodes;
communicatively coupling at least one worker node of the plurality of worker nodes to its associated respective hive node via a cellular telephone network; and
controlling, by at least one worker node of the plurality of worker nodes, a respective power infrastructure edge device of its respective power grid.

14. The method of claim 13, wherein the cellular telephone network comprises a 5G network.

15. The method of claim 14, wherein the communicatively coupling the at least one worker node of the plurality of worker nodes to its associated respective hive node via a cellular telephone network comprises the at least one worker node of the plurality of worker nodes initiating a communication channel with its associated respective hive node via a persistent 5G communication session.

16. The method of claim 14, wherein at least a first hive node of the plurality of hive nodes is communicatively coupled to at least a second hive node of the plurality of hive nodes via a wired communication channel.

17. The method of claim 13, further comprising initiating, by the at least one worker node of the plurality of worker nodes, a communication channel with its respective power infrastructure edge device of its respective power grid through a wired peer-to-peer connection, wherein the controlling comprises controlling using an industrial control system protocol.

18. The method of claim 17, wherein the industrial control system protocol forbids power infrastructure edge devices from initiating communication channels with worker nodes.

19. The method of claim 13, wherein each power grid of the plurality of power grids is self-sufficient.

20. The method of claim 13, wherein each power grid further comprises at least one respective load, wherein the controlling comprises controlling, by the at least one worker node of the plurality of worker nodes, the respective power infrastructure edge device of its respective power grid to distribute electricity to a respective load of its respective power grid, wherein the at least one worker node controls the respective power infrastructure edge device of its respective power grid to match energy requirements of the respective load of its respective power grid.

21. The method of claim 20, further comprising querying, by at least one hive node, a weather Application Program Interface (API), wherein the controlling, by at least one worker node of the plurality of worker nodes, the respective power infrastructure edge device of its respective power grid comprises the at least one worker node controlling its respective power infrastructure edge device to preemptively shut down a power distribution to its respective load in response to a predicted weather event.

22. The method of claim 13, wherein the plurality of hive nodes comprise a mesh network of hive nodes.

23. The method of claim 13, wherein each respective power infrastructure edge device comprises at least one of: a photovoltaic inverter, a solar power controller, a battery power provision system controller, a smart electricity meter, a wind turbine controller, or a power line circuit breaker.

24. The method of claim 14, wherein at least one hive node is implemented on a cloud server.
